(19) United States
(12) Patent Application Publication
(10) Pub. No.: US 2026/0195125 A1
(43) Pub. Date: Jul. 9, 2026

(54) Platform Agnostic LLM Based Uber Application Optimizing Software Development Lifecycle (SDLC) Throughput

(71) Applicant: Bank of America Corporation, Charlotte, NC (US)

(72) Inventors: Maharaj Mukherjee, Poughkeepsie, NY (US); George Albero, Charlotte, NC (US); Naga Vamsi Krishna Akkapeddi, Charlotte, NC (US)

(21) Appl. No.: 19/012,184

(22) Filed: Jan. 7, 2025

(51) Int. Cl. G06F 8/77; G06F 11/3604

(52) U.S. Cl. CPC G06F 8/77; G06F 11/3608

(57) ABSTRACT

This invention provides a platform-agnostic system and method for optimizing software development by leveraging a large language model (LLM) to extract, consolidate, and visualize technical features from diverse software components. The system employs an LLM to analyze input/output specifications, create knowledge graphs, and merge multiple graphs into a unified representation while filtering duplicate functionalities. A map traversal algorithm identifies and merges identical features, incorporating enhancements to ensure a comprehensive and up-to-date knowledge repository. The consolidated graph is processed by generative AI to generate visual, interactive representations, enabling efficient feature reuse and informed decision-making. Continuous updates with robust version control ensure adaptability to evolving requirements. The platform-agnostic plugin enables seamless integration of components developed across various technologies. This invention accelerates the software development lifecycle by reducing redundancy, fostering collaboration, and enhancing innovation, while enabling compatibility with legacy systems and facilitating scalable, efficient, and consistent software engineering processes.

### TECHNICAL FIELD

The inventions disclosed herein pertain to the field of artificial intelligence and knowledge representation systems. The invention introduces an LLM-powered system that extracts, processes, and represents technical software features as nodes within a knowledge graph. The system consolidates these graphs and generates a unified visual representation, making complex technical information accessible to developers.

### DESCRIPTION OF THE RELATED ART

In the context of software development, inefficiencies arise from the lack of visibility and collaboration among development teams working on separate projects or within distinct business units. These inefficiencies are particularly pronounced in large organizations where multiple lines of business (LOBs) operate independently, often developing software components with overlapping or identical technical features. The absence of a centralized system to identify and consolidate these overlapping efforts leads to substantial duplication of work. Developers unknowingly expend significant time and resources replicating technical features that may already exist elsewhere in the organization. This problem extends beyond individual inefficiencies, as it creates systemic delays in the software development lifecycle (SDLC), increasing costs and reducing agility.

The problem is exacerbated by the technical complexity inherent in modern software systems. Many software components are developed using diverse technologies and programming languages, tailored to specific use cases and requirements. Without a mechanism to bridge these technological divides, teams are unable to share or reuse components effectively. As a result, the development process becomes siloed, with each team solving similar problems independently, often reinventing solutions to common challenges such as data security, dynamic user interface design, and system integration.

The inability to identify and leverage existing technical features also introduces challenges in maintaining consistency across software systems. For example, one team may implement a feature using a specific encryption technique, while another team unknowingly develops a similar feature using an entirely different approach. This inconsistency not only increases redundancy but also complicates integration and interoperability between software components, leading to downstream issues in production environments. Such disparities can compromise the overall efficiency and reliability of the systems developed.

Another critical aspect of the problem is the difficulty in visualizing and understanding complex technical features before they are implemented. Developers often struggle to conceptualize how a particular feature will function within the broader context of the system. This lack of clarity can result in misaligned expectations, suboptimal design decisions, and costly rework. Furthermore, non-technical stakeholders, such as business analysts and project managers, find it even more challenging to comprehend the intricacies of technical features, hindering effective communication and collaboration between technical and non-technical teams.

The absence of a centralized repository for technical features also makes it difficult to maintain a historical record of developments. Teams may repeatedly encounter the same challenges without the ability to reference prior solutions. This lack of institutional knowledge further exacerbates inefficiencies, as valuable insights and lessons learned are lost over time. Additionally, the lack of historical data makes it challenging to track the evolution of software components, assess their effectiveness, and identify opportunities for improvement.

Organizations also face significant challenges in adapting to changes in requirements or technology. When new requirements emerge, or when technological advancements offer better solutions, teams must often start from scratch to develop new components or update existing ones. Without a mechanism to identify reusable elements, these changes necessitate significant time and resource investments, delaying the deployment of critical updates and improvements. This rigidity undermines the agility required to remain competitive in rapidly evolving markets.

The problem is particularly acute in large-scale projects that involve multiple software components developed by different teams. In such scenarios, the interdependencies between components create additional complexity. Teams must coordinate extensively to ensure that their components align with one another, a process that is prone to miscommunication and errors. The lack of a unified system to manage these interdependencies leads to delays and inefficiencies, further compounding the challenges of software development.

Another dimension of the problem is the challenge of ensuring quality and consistency across software components. Without a centralized mechanism to compare and validate technical features, there is a risk of introducing errors and inconsistencies that compromise the performance and security of the systems developed. For instance, a lack of uniformity in implementing encryption protocols or data validation techniques can create vulnerabilities that are difficult to detect and address.

The problem also extends to the integration of legacy systems with modern software components. Legacy systems often have unique requirements and constraints that must be considered during the development of new components. However, without a centralized repository of technical features and their specifications, teams face significant difficulties in designing components that can effectively integrate with legacy systems. This integration challenge further delays the deployment of new software and increases development costs.

In addition to technical challenges, the lack of visibility and collaboration also has implications for organizational efficiency and culture. Teams working in silos are less likely to share knowledge and collaborate, leading to a fragmented approach to problem-solving. This fragmentation not only reduces productivity but also undermines the potential for innovation, as teams are unable to leverage the collective expertise and creativity of the organization.

The inefficiencies in the software development process also have financial implications. Redundant efforts and extended development timelines increase costs, while delayed deployments can result in missed market opportunities. For businesses operating in competitive industries, these inefficiencies can have a significant impact on profitability and market positioning. Furthermore, the inability to deliver software solutions quickly and efficiently can erode customer trust and satisfaction, particularly in industries where responsiveness and reliability are critical.

The lack of a centralized system to identify and consolidate technical features also hampers the scalability of software development processes. As organizations grow and the complexity of their systems increases, the challenges of managing technical features and coordinating development efforts become even more pronounced. Without a scalable solution, these challenges can quickly become unmanageable, leading to widespread inefficiencies and delays.

The problem is further compounded by the rapid pace of technological change. As new technologies and methodologies emerge, organizations must continually adapt their software development processes to remain competitive. However, without a mechanism to capture and integrate these advancements into existing systems, teams struggle to keep pace with the evolving technological landscape. This inability to adapt quickly can hinder innovation and limit an organization's ability to capitalize on new opportunities.

The inefficiencies and challenges described above have persisted for decades, underscoring the long-felt and unmet need for a solution that addresses these issues comprehensively. Despite the availability of various tools and methodologies aimed at improving software development processes, none have effectively resolved the fundamental problems of redundancy, inconsistency, and inefficiency in managing technical features across projects and teams. The need for a centralized, adaptive system to streamline software development, enhance collaboration, and reduce costs has been widely recognized but remains largely unfulfilled, creating a critical opportunity for innovation.

### SUMMARY OF THE INVENTION

The invention is a sophisticated platform-agnostic system designed to revolutionize software development by enabling the efficient extraction, consolidation, and utilization of technical features from diverse software components. At its core, the invention employs a large language model, meticulously adapted to comprehend the technical nuances of software systems. This model is not merely a language processor but a comprehensive analytical tool capable of understanding complex documentation, technical specifications, and metadata associated with individual software components. By leveraging this advanced capability, the invention ensures that every feature embedded within a software component is meticulously cataloged and categorized for further use.

One of the foundational aspects of the invention is the introduction of a platform-agnostic plugin. This plugin acts as an intermediary, connecting the large language model to software components developed across different technologies and programming languages. It ensures seamless extraction of technical features, regardless of the underlying architecture or platform of the software components. These extracted features are then represented as distinct nodes within a knowledge graph. Each node is an encapsulation of a specific technical feature, enriched with its metadata, input-output relationships, and interdependencies. This representation ensures that every aspect of a technical feature is preserved in a structured and accessible format.

The invention advances the field of software engineering by enabling the creation of multiple knowledge graphs, each corresponding to a software component. These graphs are subsequently merged into a single, unified graph through advanced algorithms guided by the large language model. The consolidation process is not merely an aggregation but an intelligent merging that identifies and eliminates redundant nodes. Duplicates, which often result from independent teams developing similar functionalities, are filtered out to preserve only the unique technical features. This process is highly efficient, ensuring that the unified graph reflects the most comprehensive and non-redundant set of technical features across the organization.

A map traversal algorithm is employed to merge identical nodes within the consolidated graph. This algorithm evaluates not just the individual nodes but also their edges, connections, and dependencies, ensuring that the integration is both accurate and meaningful. This approach accommodates minor variations in otherwise identical features, combining them into a single, enriched node. By achieving this, the system creates a streamlined representation of all the technical capabilities within the organization's software assets, facilitating better resource utilization and innovation.

The consolidated knowledge graph is then processed by a generative artificial intelligence model, which transforms the graph into an interactive and highly visual representation. This visualization is not merely a static depiction but an interactive framework that allows users to explore the relationships and dependencies among technical features. Developers can assess the suitability of specific features for their projects, identify potential reuse opportunities, and understand the broader context of a feature's implementation. This intuitive visual representation bridges the gap between technical and non-technical stakeholders, enhancing communication and collaboration within the organization.

A critical aspect of the invention is its continuous adaptability and learning capabilities. As new components are developed or existing ones are updated, the knowledge graph is dynamically revised to incorporate these changes. Each revision is accompanied by version control mechanisms, such as cryptographic hashing, to ensure the integrity and traceability of historical data. This versioning capability allows teams to analyze the evolution of technical features, revert to previous iterations when necessary, and maintain a comprehensive history of changes. This feature ensures that the system remains a living repository, evolving alongside the organization's technological landscape.

The invention is further distinguished by its ability to enhance and merge technical features dynamically. When a new software component incorporates additional capabilities into an existing feature, the system updates the corresponding node to reflect these enhancements. This iterative process not only preserves the integrity of the knowledge graph but also promotes innovation by encouraging incremental improvements. By consolidating similar features with enhancements, the system fosters a culture of continuous development and refinement.

The platform-agnostic nature of the invention ensures its compatibility with a wide range of development environments and technologies. Modern software development often involves diverse tools and frameworks, and the invention's universal approach eliminates barriers to integration and collaboration. This flexibility makes the system suitable for organizations with heterogeneous technology stacks, enabling seamless interoperability and scalability across different projects and teams.

The invention's visualization capabilities are further enhanced by its graph-based architecture. These visualizations allow users to interact with the data at multiple levels, exploring detailed relationships and dependencies among features. This interactivity is particularly valuable for complex systems, where understanding the interplay between components is critical for effective decision-making. The visual framework also simplifies the process of identifying reusable features and evaluating their applicability, enabling teams to make informed decisions quickly and efficiently.

The system supports sandbox testing and validation of technical features, providing a controlled environment where developers can experiment and refine their implementations. This capability ensures that features meet project requirements and function as intended before deployment, reducing the likelihood of integration issues or performance bottlenecks. By facilitating iterative testing, the invention empowers teams to optimize their features and mitigate risks early in the development cycle.

The invention addresses the challenge of integrating legacy systems with modern software components. Legacy systems often present unique requirements and constraints, and the invention captures their technical specifications to guide the development of compatible components. This capability ensures that organizations can modernize their technology infrastructure without sacrificing the functionality or reliability of their existing systems. The seamless integration of legacy and modern components reduces development costs and streamlines the transition to new technologies.

Through its continuous updates and adaptability, the invention remains relevant in dynamic and evolving environments. It supports the long-term development needs of organizations, ensuring that their software systems keep pace with technological advancements and changing requirements. By incorporating new features and enhancements into its knowledge graph, the system provides a foundation for sustained innovation and growth.

The invention significantly accelerates the software development lifecycle by reducing redundancy, enhancing collaboration, and promoting the reuse of technical features. By centralizing and consolidating technical knowledge, it empowers teams to work more efficiently and effectively. Its ability to provide visual insights into technical features, support iterative refinement, and ensure compatibility across platforms represents a groundbreaking advancement in software engineering. This invention transforms the way technical features are managed and utilized, offering a scalable and flexible solution that addresses the complex challenges of modern software development.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for optimizing software development processes includes providing, by a large language model processor, an analysis of technical documentation associated with one or more software components. This analysis extracts technical features, input specifications, and output specifications of each software component. The method further includes generating, by a platform-agnostic plugin, a knowledge graph for each of the one or more software components, where each knowledge graph comprises nodes representing the extracted technical features and edges representing dependencies between the nodes. Additionally, the method merges, by a graph consolidation module, the knowledge graphs into a unified knowledge graph. The merging includes filtering duplicate nodes, identifying unique nodes using a map traversal algorithm, and combining identical nodes with minor variations while preserving their input and output edge relationships. The unified knowledge graph is fed, by a generative artificial intelligence engine, to generate a visual representation of the technical features, which includes interactive elements to explore relationships and dependencies among the nodes. The method also updates, by a dynamic learning module, the unified knowledge graph upon modifications to the software components, creating version-controlled revisions maintained with cryptographic hashes. Lastly, the method validates, by a sandbox testing environment, the technical features in the visual representation for specific projects prior to implementation.

In some arrangements, the method further comprises prioritizing, by the large language model processor, the extracted technical features based on predefined criteria. These criteria include frequency of use, complexity, and relevance to ongoing software development projects.

In some arrangements, the method includes generating, by the platform-agnostic plugin, knowledge graphs that annotate each node with metadata. The metadata includes historical usage data, dependencies, and associated risks for the respective technical features.

In some arrangements, the method further comprises tagging, by the graph consolidation module, each node in the unified knowledge graph with a unique identifier. The unique identifier links the node to its source software component, ensuring traceability of the technical features.

In some arrangements, the method includes resolving, by the graph consolidation module, conflicts among technical features detected during the merging process. The resolution is based on a predefined conflict-resolution protocol that evaluates overlapping functionalities and contradictory dependencies.

In some arrangements, the method further comprises generating, by the generative artificial intelligence engine, multiple versions of the visual representation of the unified knowledge graph. Each version is tailored to a specific audience, including developers, project managers, and non-technical stakeholders.

In some arrangements, the method includes enabling, by the user interface module, modifications to the nodes in the visual representation. The modifications are automatically reflected in the unified knowledge graph, ensuring the graph remains up to date with user interactions.

In some arrangements, the method further comprises generating, by the generative artificial intelligence engine, a report summarizing the technical features represented in the unified knowledge graph. The report includes recommendations for reuse, enhancements, or elimination of redundant features.

In some arrangements, the method includes monitoring, by the dynamic learning module, changes in the source software components in real-time. The monitoring triggers automated updates to the unified knowledge graph and ensures consistency by comparing the changes to historical versions.

In some arrangements, the method further comprises simulating, by the sandbox testing environment, integration scenarios for the technical features represented in the visual representation. The simulations assess compatibility and performance in multi-component systems and include iterative refinements to optimize feature performance and alignment with project requirements.

In some arrangements, a method for optimizing software development processes includes analyzing, by a large language model processor, technical documentation associated with one or more software components, wherein the analysis includes extracting technical features, input specifications, and output specifications of each software component. The method further comprises prioritizing, by the large language model processor, the extracted technical features based on predefined criteria, including frequency of use, complexity, and relevance to current software development projects. The method also includes generating, by a platform-agnostic plugin, a knowledge graph for each of the one or more software components, where each knowledge graph comprises nodes representing the extracted technical features of the respective software component and edges representing dependencies between the nodes of the respective software component. Each node in the knowledge graph is annotated with metadata, including historical usage data, dependencies, and associated risks.

The method includes merging, by a graph consolidation module, the knowledge graphs into a unified knowledge graph, where merging involves filtering duplicate nodes across the knowledge graphs, identifying unique nodes using a map traversal algorithm, and tagging each node with a unique identifier linking the node to its source software component. Conflicts among technical features are resolved, by the graph consolidation module, based on a predefined conflict-resolution protocol, where the conflicts are detected through evaluations of overlapping functionality or contradictory dependencies. The method further includes combining, by the graph consolidation module, identical nodes within the unified knowledge graph that have minor variations, where the combining incorporates enhancements to the technical features and preserves the input and output edge relationships of the identical nodes.

The method further comprises feeding, by a generative artificial intelligence engine, the unified knowledge graph to generate a visual representation of the technical features represented in the unified knowledge graph. The visual representation includes interactive elements configured to explore relationships and dependencies among the nodes of the unified knowledge graph. The generative artificial intelligence engine generates multiple versions of the visual representation, each version tailored to specific audiences, including developers, project managers, and non-technical stakeholders. The method includes enabling, by a user interface module, visualization and exploration of the technical features and their interconnections as represented in the visual representation. The user interface module allows modifications to the nodes in the visual representation, where the modifications are automatically reflected in the unified knowledge graph.

The method further includes generating, by the generative artificial intelligence engine, a report summarizing the technical features represented in the unified knowledge graph, where the report includes recommendations for reuse, enhancements, or elimination of redundant features. The method comprises updating, by a dynamic learning module, the unified knowledge graph upon modifications to the one or more software components. This updating includes monitoring changes in the source software components in real-time, triggering automated updates to the unified knowledge graph, and creating version-controlled revisions of the unified knowledge graph, where the revisions are maintained with cryptographic hashes to ensure data integrity. The method further comprises integrating, by the platform-agnostic plugin, additional software components developed in diverse technologies. This integration includes extracting technical features of the additional software components and incorporating the extracted technical features into the unified knowledge graph. Finally, the method includes validating, by a sandbox testing environment, the suitability of the technical features represented in the visual representation for specific projects prior to implementation. This validation includes simulating integration scenarios for the technical features to assess compatibility and performance in multi-component systems and performing iterative refinements to optimize performance and alignment with project requirements.

In some arrangements, a system for optimizing software development processes includes a large language model processor configured to analyze technical documentation associated with one or more software components, wherein the analysis extracts technical features, input specifications, and output specifications of each software component. The large language model processor is further configured to prioritize the extracted technical features based on predefined criteria, including frequency of use, complexity, and relevance to current software development projects. The system also includes a platform-agnostic plugin configured to generate a knowledge graph for each of the one or more software components, where each knowledge graph comprises nodes representing the extracted technical features and edges representing dependencies between the nodes. Each node in the knowledge graph is annotated with metadata that includes historical usage data, dependencies, and associated risks.

The system further includes a graph consolidation module configured to merge the knowledge graphs into a unified knowledge graph. The merging involves filtering duplicate nodes, identifying unique nodes using a map traversal algorithm, and tagging each node with a unique identifier linking the node to its source software component. The graph consolidation module is also configured to resolve conflicts among technical features during the merging process based on a predefined conflict-resolution protocol and to combine identical nodes with minor variations while incorporating enhancements to the technical features and preserving input and output edge relationships. Additionally, the system includes a generative artificial intelligence engine configured to generate a visual representation of the technical features in the unified knowledge graph, wherein the representation includes interactive elements for exploring relationships and dependencies among the nodes.

The generative artificial intelligence engine is further configured to generate multiple versions of the visual representation tailored to specific audiences, including developers, project managers, and non-technical stakeholders. The system includes a user interface module that enables visualization and exploration of the technical features and their interconnections in the visual representation. The user interface module allows modifications to the nodes in the visual representation, where the modifications are automatically reflected in the unified knowledge graph. The generative artificial intelligence engine is also configured to generate a report summarizing the technical features represented in the unified knowledge graph, where the report includes recommendations for reuse, enhancements, or elimination of redundant features.

The system includes a dynamic learning module configured to update the unified knowledge graph upon modifications to the one or more software components. This updating involves monitoring changes in the source software components in real-time, triggering automated updates, and creating version-controlled revisions of the unified knowledge graph, where the revisions are maintained with cryptographic hashes to ensure data integrity. Additionally, the platform-agnostic plugin is configured to integrate additional software components developed in diverse technologies, where the integration includes extracting technical features of the additional software components and incorporating them into the unified knowledge graph. The system also includes a sandbox testing environment configured to validate the suitability of the technical features in the visual representation for specific projects prior to implementation. The validation involves simulating integration scenarios and performing iterative refinements to optimize performance and alignment with project requirements.

In some arrangements, the system further comprises the large language model processor configured to classify the extracted technical features into predefined categories, including data security, user interface design, and system integration.

In some arrangements, the system includes the platform-agnostic plugin further configured to annotate each node in the knowledge graph with contextual information, including the development environment, associated technologies, and implementation constraints of the source software component.

In some arrangements, the system includes the graph consolidation module further configured to detect inconsistencies among the dependencies of nodes during the merging process and to resolve these inconsistencies by modifying edge relationships while preserving the logical integrity of the unified knowledge graph.

In some arrangements, the system includes the generative artificial intelligence engine further configured to provide predictive insights into potential usage of the technical features based on historical usage data and patterns identified within the unified knowledge graph.

In some arrangements, the system includes the user interface module further configured to allow users to filter and search for technical features within the visual representation based on predefined criteria, including functionality, dependencies, and metadata attributes.

In some arrangements, the system includes the dynamic learning module further configured to compare real-time updates to the unified knowledge graph with historical versions, where the comparison identifies potential conflicts or redundancies introduced by the updates and suggests resolutions.

In some arrangements, the system includes the platform-agnostic plugin further configured to generate compatibility reports for additional software components integrated into the unified knowledge graph, where the reports include recommendations for adjustments required to ensure seamless integration.

In some arrangements, the system includes the sandbox testing environment further configured to perform stress testing of the technical features represented in the visual representation, where the stress testing evaluates the features under simulated high-load and edge-case conditions to ensure robustness and scalability.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts the system architecture for the invention, illustrating the flow of data and processes among key components, including the large language model processor, platform-agnostic plugin, graph consolidation module, unified knowledge graph, and generative artificial intelligence engine. The figure shows interactions among technical documentation input, software components, sandbox testing environment, dynamic learning module, and user interface module, leading to outputs such as visualized representations, feature validation feedback, and reports and insights.

FIG. 2 depicts a flow diagram illustrating the sequential operations of the system, starting with the analysis of technical documentation using the LLM processor and progressing through steps such as feature prioritization, knowledge graph generation, graph consolidation, conflict resolution, and visualization generation. It further includes validation of features in the sandbox testing environment, iterative refinements, and updating of the unified knowledge graph, culminating in the completion of all criteria.

FIG. 3 depicts a sequence diagram illustrating the interactions between system components and the user, starting with the submission of technical documentation and software components, followed by feature extraction, knowledge graph generation, graph consolidation, and visualization creation. It further includes iterative user interactions for updating the unified knowledge graph, sandbox validation of features, and the generation of recommendations and insights.

FIG. 4 depicts a class diagram illustrating the structural relationships, attributes, and methods of the system's components. It shows the connections between these classes, their methods (e.g., feature extraction, graph generation, conflict resolution, and visualization), and the flow of interactions such as updates, validations, and visualizations.

### DETAILED DESCRIPTION

The invention is a comprehensive system and method designed to optimize software development processes by enabling the identification, consolidation, and utilization of technical features from diverse software components. At its core, the invention leverages a large language model (LLM) adapted to analyze technical documentation, extracting detailed features such as input and output specifications and functional requirements. This foundational capability ensures that the system can understand and process technical complexities inherent in modern software systems, forming the basis for subsequent stages of feature organization and reuse.

One of the key aspects of the invention is its ability to generate knowledge graphs for individual software components using a platform-agnostic plugin. Each knowledge graph represents the extracted technical features as nodes, with edges denoting the dependencies and relationships between them. This structured representation ensures that all critical information about a software component is encapsulated in a clear and accessible format. Additionally, the nodes in the knowledge graph are annotated with metadata, such as historical usage data and associated risks, enhancing their utility for future reference.

The invention employs a graph consolidation module to merge multiple knowledge graphs into a single unified graph. This process involves filtering out duplicate nodes, identifying unique features, and combining identical nodes that may have minor variations. The merging process ensures that the unified graph provides a streamlined and non-redundant representation of all technical features across an organization's software assets. The use of a map traversal algorithm further enhances the accuracy of node integration, preserving critical relationships while eliminating redundancies.

Another innovative aspect of the invention is its ability to resolve conflicts among technical features during the merging process. The graph consolidation module evaluates overlapping functionalities and contradictory dependencies, applying a predefined conflict-resolution protocol to address such issues. This capability ensures that the unified knowledge graph maintains logical consistency and accuracy, providing a reliable foundation for subsequent processes.

The unified knowledge graph is further processed by a generative artificial intelligence engine to create visual representations of the technical features. These visualizations are interactive, allowing users to explore the relationships and dependencies among features. By offering multiple versions tailored to different audiences, such as developers, project managers, and non-technical stakeholders, the invention ensures that the visual representations are accessible and informative for all users. This versatility enhances collaboration and decision-making across diverse teams.

A user interface module complements the visualization capabilities by enabling users to interact with the visual representations. Users can modify nodes or explore specific relationships within the graph, and these changes are automatically reflected in the unified knowledge graph. This bidirectional integration ensures that the graph remains dynamic and adaptable to evolving requirements or user inputs, making it a powerful tool for software development.

The invention also supports continuous learning and updates through a dynamic learning module. This module monitors changes to the source software components in real-time, triggering automated updates to the unified knowledge graph. Each update generates a new version of the graph, which is maintained with cryptographic hashes to ensure data integrity and traceability. This versioning capability allows teams to track the evolution of technical features and revert to previous states if needed.

Another critical aspect of the invention is its ability to integrate additional software components developed using diverse technologies. The platform-agnostic plugin ensures compatibility with various development environments, extracting technical features from new components and incorporating them into the unified knowledge graph. This adaptability makes the system scalable and suitable for use in organizations with heterogeneous technology stacks.

The invention also includes a sandbox testing environment for validating technical features before implementation. This environment simulates integration scenarios, assessing the compatibility and performance of features in multi-component systems. By identifying potential issues early in the development process, the sandbox environment reduces the risk of errors and optimizes feature alignment with project requirements. Iterative refinements can also be performed within this environment, further enhancing feature performance.

A generative artificial intelligence engine within the invention generates detailed reports summarizing the technical features in the unified knowledge graph. These reports include recommendations for reusing existing features, making enhancements, or eliminating redundant functionalities. This capability supports informed decision-making, enabling teams to optimize resource utilization and reduce development costs.

The invention's visualization and reporting capabilities also promote consistency and standardization across software components. By providing a centralized repository of reusable features, the system encourages uniform implementation practices, reducing the likelihood of errors and incompatibilities. This standardization enhances the maintainability and reliability of software systems, particularly in large-scale projects involving multiple teams.

The invention is particularly effective in addressing the challenges of integrating legacy systems with modern software components. By capturing the technical specifications and constraints of legacy systems, the unified knowledge graph facilitates the design of compatible components. This capability ensures that organizations can modernize their technology infrastructure without sacrificing the functionality or stability of existing systems.

Through its continuous updating and learning mechanisms, the invention remains relevant in dynamic environments where software requirements and technologies are constantly evolving. By incorporating new features and addressing emerging challenges, the system supports long-term development efforts and fosters innovation. This adaptability ensures that the invention can keep pace with the rapid advancements in software engineering.

The invention also offers predictive insights into potential feature usage, based on historical data and patterns within the unified knowledge graph. These insights help teams prioritize development efforts, focusing on features that are most likely to deliver value. This predictive capability further enhances the efficiency and effectiveness of the software development lifecycle.

By centralizing and streamlining the management of technical features, the invention reduces redundancy, accelerates development timelines, and enhances collaboration among teams. Its ability to provide clear, visual representations of complex relationships and support iterative refinements makes it a transformative tool for software development. This invention represents a significant advancement in the field, addressing longstanding challenges and paving the way for more efficient, scalable, and innovative software engineering practices.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

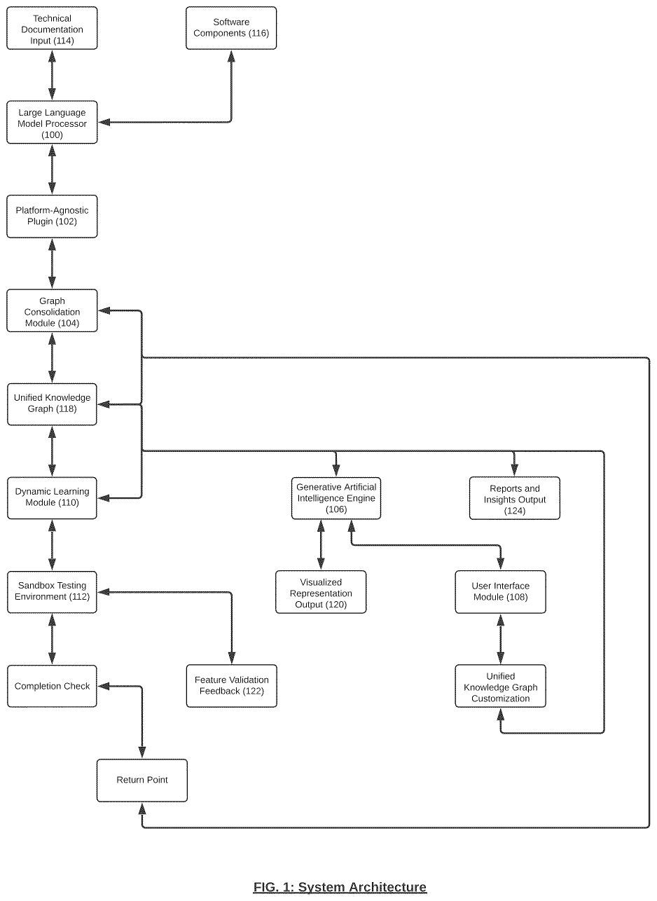

FIG. 1 provides a comprehensive and detailed depiction of the system architecture, illustrating the intricate relationships and functionality of its components. The system begins with the Large Language Model Processor, labeled as 100, which serves as the central hub for analyzing technical documentation, represented by 114, and software components, labeled 116. This processor performs the critical function of extracting technical features from the inputs, identifying input and output specifications, dependencies, and functional requirements. These features are further prioritized based on key criteria such as their frequency of use in existing systems, their complexity, and their relevance to ongoing or planned software development projects. By systematically prioritizing features, the Large Language Model Processor ensures that high-value features are identified early in the workflow, enabling a focus on the most impactful components for subsequent analysis and reuse.

Once the technical features have been extracted and prioritized, they are forwarded to the Platform-Agnostic Plugin, labeled 102. This plugin plays a pivotal role in creating individual knowledge graphs for each software component. Each knowledge graph is a structured representation of the features extracted from a given component, with nodes representing individual features and edges defining their dependencies and relationships. The Platform-Agnostic Plugin enriches these graphs with metadata such as historical usage data, associated risks, and constraints, ensuring that the graphs capture the full context of each feature. The system's agnostic nature allows it to operate seamlessly across diverse technologies and frameworks, making it highly adaptable to different development environments and ensuring compatibility with various software architectures.

The knowledge graphs generated by the Platform-Agnostic Plugin are then passed to the Graph Consolidation Module, labeled 104. This module performs a series of sophisticated operations to consolidate the individual knowledge graphs into a Unified Knowledge Graph, labeled 118. One of the primary functions of the Graph Consolidation Module is to filter duplicate nodes to remove redundancies and streamline the graph. It also merges identical nodes that may have minor variations, ensuring that all technical features are uniquely represented while preserving their relationships and metadata. Additionally, the module resolves conflicts that arise from overlapping or contradictory features. This conflict-resolution process is guided by a predefined protocol that evaluates dependencies, historical data, and usage patterns to determine the optimal resolution. The result is a logically consistent and non-redundant Unified Knowledge Graph that serves as the central repository of technical features for the entire system.

The Unified Knowledge Graph is a cornerstone of the system and is subsequently processed by the Generative Artificial Intelligence Engine, labeled 106. This engine creates interactive visualizations of the Unified Knowledge Graph, allowing users to explore the relationships between features, dependencies, and metadata in a clear and intuitive manner. The visualizations are tailored to different user groups, including developers, project managers, and non-technical stakeholders, ensuring that the information is presented in an accessible and actionable format. The Generative Artificial Intelligence Engine also generates detailed reports that summarize the features in the Unified Knowledge Graph, offer recommendations for reuse, suggest enhancements, and highlight redundant functionalities. These visualizations and reports empower users to make informed decisions about feature utilization and system optimization.

The User Interface Module, labeled 108, provides a dynamic platform for interacting with the visualized representation of the Unified Knowledge Graph. Users can explore the graph, search for specific nodes, and modify features or metadata as needed. Any modifications made through the User Interface Module are automatically synchronized with the Unified Knowledge Graph, ensuring that the system remains up-to-date and responsive to user inputs. This capability allows users to tailor the graph to meet specific project requirements or organizational objectives, enhancing the system's flexibility and utility.

The Dynamic Learning Module, labeled 110, monitors changes in the source software components, represented by 116, and technical documentation, represented by 114, in real-time. This module updates the Unified Knowledge Graph to reflect any new features, modifications, or deletions, ensuring that the graph evolves alongside the software it represents. The Dynamic Learning Module employs version control mechanisms, including cryptographic hashes, to maintain an auditable record of all changes. This ensures data integrity and allows users to track the evolution of features over time, providing valuable insights into their development and usage.

The Sandbox Testing Environment, labeled 112, plays a critical role in validating the features represented in the Unified Knowledge Graph. It simulates integration scenarios to test the compatibility and performance of features in multi-component systems. The results of these simulations are analyzed to identify potential issues, refine features, and ensure their alignment with project requirements. Feedback from the Sandbox Testing Environment is looped back into the Unified Knowledge Graph for further validation and refinement, creating a continuous cycle of improvement.

The system produces several key outputs that enhance its usability and effectiveness. The Visualized Representation, labeled 120, is the interactive visualization generated by the Generative Artificial Intelligence Engine. It provides users with an intuitive way to explore and manipulate the Unified Knowledge Graph. The Feature Validation Feedback, labeled 122, presents the results of the Sandbox Testing Environment, including compatibility scores, performance metrics, and recommendations for refinement. Additionally, the system generates Reports and Insights, labeled 124, which provide comprehensive summaries of the Unified Knowledge Graph, identify reusable features, and offer actionable recommendations for system optimization.

The entire architecture operates as a highly integrated and iterative system, with components working in concert to ensure that the Unified Knowledge Graph remains accurate, up-to-date, and aligned with user needs. FIG. 1 emphasizes the modularity and adaptability of the system, showcasing how each component contributes to the overarching goal of optimizing software development processes. By integrating all aspects of the system claims and their functionalities, FIG. 1 highlights the invention's ability to streamline development workflows, enhance feature reuse, and provide actionable insights, making it a transformative tool for modern software engineering practices. This detailed depiction of the system architecture underscores its capability to meet the demands of complex, dynamic development environments while maintaining logical consistency, scalability, and usability.

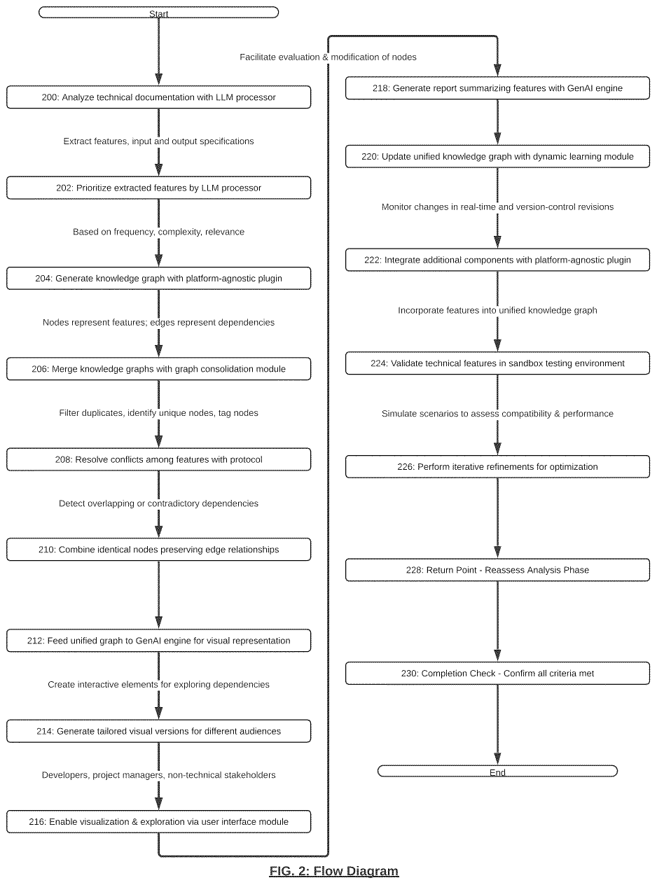

FIG. 2 presents an intricate flow diagram that provides a comprehensive view of the sequential operations within the system, highlighting the interconnections, functionality, and iterative processes that define the invention. The system begins its operation at step 200, where technical documentation, labeled as 114, and software components, labeled as 116, are introduced as inputs. These inputs are processed by the Large Language Model Processor, labeled as 100, which is designed to extract critical technical features from the provided documentation and components. This extraction process identifies key elements such as input specifications, output specifications, functional requirements, and interdependencies. The extraction process is meticulously carried out to ensure that all relevant details are captured, even when the features are complex or deeply embedded within the documentation or codebase.

Following the extraction, step 202 describes the prioritization of the technical features by the Large Language Model Processor. The processor applies predefined criteria such as the frequency of feature usage, its inherent complexity, and its relevance to ongoing or planned software development projects. This prioritization ensures that high-value features are identified and given precedence in downstream operations. This feature prioritization mechanism is essential for enhancing the efficiency of the system by focusing on impactful components, thereby aligning with the claims of the invention.

At step 204, the prioritized features are forwarded to the Platform-Agnostic Plugin, labeled as 102, which processes the extracted data to generate individual knowledge graphs for each software component. These knowledge graphs provide a structured representation of the technical features, where each node corresponds to a feature and the edges define the relationships and dependencies between these nodes. Additionally, these knowledge graphs are enriched with metadata, including historical usage data, associated risks, implementation constraints, and performance metrics, making them highly informative and actionable. The platform-agnostic nature of this plugin, as claimed in the invention, ensures compatibility with a wide variety of technologies and development frameworks, enhancing the versatility of the system.

In step 206, the individual knowledge graphs are sent to the Graph Consolidation Module, labeled as 104, where they are merged into a Unified Knowledge Graph, labeled as 118. This step represents a pivotal moment in the system's operation, as the consolidation process integrates all extracted features into a single, coherent structure. The Graph Consolidation Module performs several advanced operations, including filtering duplicate nodes to eliminate redundancies, merging identical nodes with minor variations, and resolving conflicts among overlapping or contradictory features. The conflict resolution protocol evaluates dependencies, metadata, and historical usage patterns to ensure that the Unified Knowledge Graph maintains logical consistency and accurately represents the underlying data. This graph serves as the central repository of technical features, capturing their interrelationships in a streamlined and comprehensive manner.

Once the Unified Knowledge Graph has been consolidated, it is processed by the Generative Artificial Intelligence Engine, labeled as 106, in step 212. The AI engine creates an interactive visual representation of the Unified Knowledge Graph, allowing users to explore its contents intuitively. This visualization is a key feature of the invention, enabling users to interact with complex technical data in a manageable and accessible format. The visualization includes interactive elements that allow users to investigate dependencies, relationships, and the hierarchical structure of features. The engine also tailors the visualization for different audiences, such as developers, project managers, and non-technical stakeholders, ensuring that the information is presented in a manner that is both relevant and understandable. In addition to visualization, the engine generates detailed reports summarizing the Unified Knowledge Graph's contents. These reports include actionable recommendations for reusing existing features, improving functionality, and eliminating redundancies, as described in the system claims.

At step 216, the visualization is delivered to the User Interface Module, labeled as 108. This module serves as the primary interface for users to interact with the Unified Knowledge Graph. Users can modify nodes, update metadata, and explore relationships directly within the interface. All user modifications are reflected in the graph in real time, ensuring that it remains dynamic and responsive to user inputs. This functionality enhances the adaptability of the system, allowing it to meet the specific needs of different projects and organizational objectives.

The Dynamic Learning Module, labeled as 110, operates continuously to monitor changes in the source software components and technical documentation. Step 220 describes how this module updates the Unified Knowledge Graph whenever new features are added, existing features are modified, or obsolete features are removed. The module employs cryptographic hashes to maintain a secure and auditable record of all changes, ensuring data integrity and traceability. This iterative update process ensures that the Unified Knowledge Graph evolves in step with the underlying software, maintaining its relevance and utility over time.

Validation of the Unified Knowledge Graph occurs in the Sandbox Testing Environment, labeled as 112, which is detailed in step 224. This environment simulates real-world integration scenarios to test the compatibility and performance of the technical features. The results of these simulations are analyzed to identify potential compatibility issues, performance bottlenecks, and other shortcomings. Based on these results, step 226 involves refining the features within the Unified Knowledge Graph to address the identified issues, ensuring that the graph is optimized for deployment in live systems. The feedback generated during this process is looped back into earlier stages of the workflow, creating a continuous cycle of validation and improvement.

The system's outputs include the Visualized Representation, labeled as 120, which provides an interactive view of the Unified Knowledge Graph for user exploration and modification. The Feature Validation Feedback, labeled as 122, summarizes the results of the Sandbox Testing Environment, including compatibility scores, performance metrics, and refinement recommendations. Finally, the Reports and Insights Output, labeled as 124, provides a comprehensive overview of the Unified Knowledge Graph, highlighting reusable features, suggesting enhancements, and identifying redundant functionalities.

FIG. 2 encapsulates the essence of the invention by demonstrating the iterative and dynamic nature of its operations. Feedback loops between the system components ensure continuous updates, refinements, and validations, making the Unified Knowledge Graph a living document that evolves alongside the software it represents. The diagram integrates all key features of the invention, including feature extraction, prioritization, consolidation, visualization, validation, and reporting, while addressing the applicable limitations of the method and system claims. The intricate workflow depicted in FIG. 2 underscores the modularity, scalability, and adaptability of the system, illustrating how it effectively optimizes software development processes in a comprehensive and systematic manner.

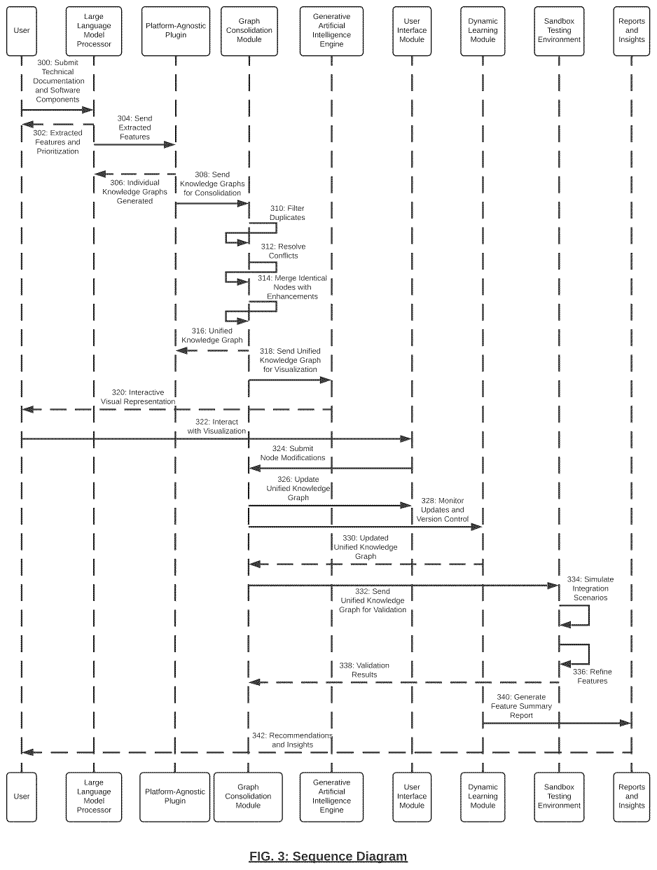

FIG. 3 illustrates the sequence of interactions between the system's components and the user in exceptional detail, emphasizing the operational flow and showcasing the interdependencies that make the invention a comprehensive solution for optimizing software development processes. The sequence begins with the user submitting two primary inputs: technical documentation, labeled as 114, and software components, labeled as 116. These inputs are received by the Large Language Model Processor, labeled as 100, which undertakes the critical task of extracting technical features from the provided data. This extraction process meticulously identifies input and output specifications, dependencies, and functional requirements, ensuring that every technical aspect is comprehensively captured. The system's capability to analyze and break down complex technical information into discrete, usable elements is fundamental to the invention and aligns with the method claims.

After extracting the features, the Large Language Model Processor prioritizes them in step 302 based on predefined criteria, including their frequency of use, inherent complexity, and relevance to ongoing or planned projects. This prioritization is key to ensuring that high-impact features are processed first, enabling the system to optimize the downstream workflow. By focusing resources on critical features, the system reduces processing overhead and enhances decision-making efficiency, as outlined in the claims.

In step 304, the prioritized features are transferred to the Platform-Agnostic Plugin, labeled as 102, which processes them to create individual knowledge graphs for each software component. These knowledge graphs, generated in step 306, represent the extracted features as nodes, while edges define the relationships and dependencies between them. Each graph is enriched with metadata, such as historical usage data, associated risks, and implementation constraints, making them highly informative and actionable for subsequent stages. The platform-agnostic nature of this component ensures that the system is adaptable to various technologies and frameworks, enabling integration across diverse software environments. This adaptability is one of the invention's core strengths and is explicitly addressed in the claims.

The individual knowledge graphs are then sent to the Graph Consolidation Module, labeled as 104, for integration into a Unified Knowledge Graph, labeled as 118. Step 308 initiates this process by filtering out duplicate nodes to eliminate redundancies. Step 310 resolves conflicts among overlapping or contradictory features by employing a predefined protocol that evaluates dependencies, metadata, and historical usage. This ensures that the resulting graph is logically consistent and accurate. In step 312, identical nodes are merged while preserving their relationships and associated metadata, resulting in a streamlined representation of the features. The culmination of this process in step 314 is the Unified Knowledge Graph, which serves as a central repository for all extracted and consolidated technical features. The Unified Knowledge Graph's ability to provide a cohesive and logically consistent representation of technical data is a critical aspect of the invention and directly supports the system claims.

Step 316 transitions the process to the Generative Artificial Intelligence Engine, labeled as 106, which creates an interactive visual representation of the Unified Knowledge Graph. This visualization allows users to intuitively explore the graph's structure, investigate dependencies, and analyze relationships between features. The engine tailors these visualizations for different user groups, such as developers, project managers, and non-technical stakeholders, ensuring that the data is presented in a format that is accessible and relevant. The customization of visual outputs is a key feature of the invention, enabling stakeholders at all levels to derive actionable insights from the Unified Knowledge Graph.

The visualization is delivered to the User Interface Module, labeled as 108, in step 320. Through this module, users can interact with the graph by modifying nodes, updating metadata, and exploring dependencies. Step 322 details how user inputs are applied in real time to update the Unified Knowledge Graph, ensuring that the system remains dynamic and responsive to evolving requirements. This iterative interaction allows users to refine the graph to meet specific project needs, enhancing the system's flexibility and usability.

As updates are applied, the Dynamic Learning Module, labeled as 110, continuously monitors changes in the source software components and technical documentation. Step 328 involves updating the Unified Knowledge Graph to reflect these changes, with cryptographic hashes employed to maintain an auditable and secure record of modifications. This ensures that the graph evolves in alignment with the underlying software and remains a reliable resource for stakeholders. The integration of real-time updates and secure version control is a critical feature of the invention, supporting its adaptability and transparency.

The system's validation phase begins in step 332, where the Unified Knowledge Graph is sent to the Sandbox Testing Environment, labeled as 112. This environment simulates integration scenarios to evaluate the compatibility and performance of the features represented in the graph. In step 334, the results of these simulations are analyzed to identify compatibility issues, performance bottlenecks, and other potential challenges. Based on these findings, step 336 refines the graph to address the identified issues, ensuring that it meets project requirements and is optimized for deployment. The feedback loop created by this validation phase ensures continuous improvement, aligning the system with the claims that emphasize iterative refinement and validation.

The outputs of the system are highlighted in the final steps of the sequence. In step 340, the Generative Artificial Intelligence Engine generates a detailed report summarizing the findings from the Unified Knowledge Graph. This report includes actionable insights, such as recommendations for reusing features, improving functionality, and eliminating redundancies. Step 342 delivers additional outputs in the form of recommendations and insights, equipping stakeholders with the information needed to make informed decisions about feature utilization and optimization.

FIG. 3 encapsulates the entire workflow of the invention, integrating all key features and addressing the limitations of the method and system claims. The sequence diagram demonstrates how the system's components interact seamlessly to extract, prioritize, consolidate, validate, and visualize technical features, creating a robust and adaptable framework for software development. By highlighting the iterative and dynamic nature of the system, the diagram underscores its capacity to evolve alongside the software it supports, ensuring that it remains relevant and effective in addressing complex development challenges. The detailed representation of processes and feedback loops in FIG. 3 provides a clear understanding of the invention's comprehensive capabilities, scalability, and transformative potential.

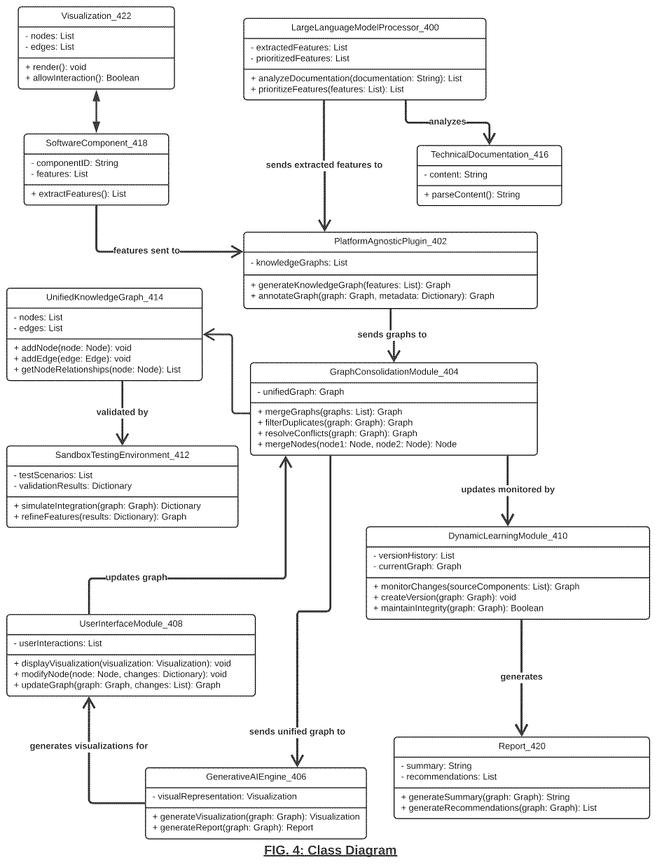

FIG. 4 presents a highly detailed class diagram that meticulously illustrates the structural architecture of the invention, providing a comprehensive view of the components, their attributes, methods, and interrelations. The diagram captures the system's sophistication, modularity, and ability to manage the complexities of software development processes through an interconnected and dynamic architecture. Each class is clearly defined, reflecting its unique role within the system, while the relationships between the classes establish the logical flow of data and operations, ensuring seamless integration and iterative functionality.

At the core of the system is the LargeLanguageModelProcessor, labeled as 400. This processor is responsible for the foundational task of analyzing technical documentation, labeled as 416, and software components, labeled as 418, to extract critical technical features. The attributes of the LargeLanguageModelProcessor include extractedFeatures, which stores the features identified during the analysis, and prioritizedFeatures, which organizes these features based on their relevance, complexity, and frequency of use. This prioritization is performed through the methods analyzeDocumentation and prioritizeFeatures. The analyzeDocumentation method processes the content of the technical documentation, breaking it down into discrete, actionable elements, while prioritizeFeatures applies ranking algorithms to ensure that high-value features are given precedence. These capabilities align directly with the claims of the invention, which emphasize efficient feature extraction and prioritization to optimize the software development process.

The PlatformAgnosticPlugin, labeled as 402, serves as the next critical component in the system. Its primary function is to generate individual knowledge graphs that represent the extracted technical features. The attributes of this plugin include knowledgeGraphs, which store these structured representations. The generateKnowledgeGraph method creates these graphs, where nodes represent the features and edges denote the dependencies and relationships between them. Additionally, the annotateGraph method enriches these graphs with metadata, such as historical usage, risk assessments, and implementation constraints, ensuring that the knowledge graphs are comprehensive and actionable. The platform-agnostic nature of this plugin allows it to operate seamlessly across diverse technological environments, a capability explicitly claimed in the invention to enhance its versatility and scalability.

The GraphConsolidationModule, labeled as 404, integrates the individual knowledge graphs generated by the PlatformAgnosticPlugin into a UnifiedKnowledgeGraph, labeled as 414. This consolidated graph serves as the centralized repository for all technical features, capturing the relationships and interdependencies among them in a streamlined and cohesive format. The attributes of the GraphConsolidationModule include unifiedGraph, which stores the final, integrated representation. Its methods include mergeGraphs, which combines multiple graphs into one; filterDuplicates, which removes redundant nodes to reduce clutter; resolveConflicts, which addresses overlapping or contradictory features through a predefined resolution protocol; and mergeNodes, which consolidates identical nodes while preserving their relationships. These operations ensure that the UnifiedKnowledgeGraph is logically consistent, non-redundant, and optimized for usability, reflecting the claims'emphasis on structured and efficient data management.

The GenerativeAIEngine, labeled as 406, processes the UnifiedKnowledgeGraph to create actionable outputs that enhance user understanding and decision-making. Its attributes include visualRepresentation, which stores the interactive graphical depiction of the graph. The methods generateVisualization and generateReport allow the engine to produce user-friendly visualizations and detailed textual summaries, respectively. The visualizations enable users to explore the graph dynamically, investigating dependencies and relationships in an intuitive manner, while the reports provide actionable insights, such as recommendations for reusing features, enhancing functionality, and eliminating redundancies. These outputs are tailored for diverse user groups, including technical experts, project managers, and non-technical stakeholders, ensuring accessibility and usability.

The UserInterfaceModule, labeled as 408, is the component through which users interact with the system. Its attributes include userInteractions, which record user inputs and modifications. The methods displayVisualization, modifyNode, and updateGraph facilitate dynamic exploration and editing of the UnifiedKnowledgeGraph. This module ensures that user inputs are synchronized in real-time with the graph, maintaining its relevance and accuracy. By enabling users to refine the graph iteratively, the UserInterfaceModule supports the system's adaptability to evolving project requirements and organizational goals.

The DynamicLearningModule, labeled as 410, ensures that the UnifiedKnowledgeGraph remains up-to-date and aligned with changes in the underlying technical documentation and software components. Its attributes include versionHistory, which tracks all modifications, and currentGraph, which stores the most recent version. The methods monitorChanges, createVersion, and maintainIntegrity enable the module to reflect updates in the source data while preserving a secure and auditable record of changes through cryptographic hashing. This capability enhances the transparency and reliability of the system, aligning with the claims that emphasize iterative updates and traceability.

The SandboxTestingEnvironment, labeled as 412, validates the features represented in the UnifiedKnowledgeGraph through simulated integration scenarios. Its attributes include testScenarios, which define the conditions for testing, and validationResults, which capture the outcomes. The methods simulateIntegration and refineFeatures enable the system to identify and address compatibility issues, performance bottlenecks, and other potential challenges. The feedback generated during this process is looped back into the system for further refinement, ensuring continuous improvement and alignment with functional requirements.

Additional outputs are generated by the Report, labeled as 420, and Visualization, labeled as 422, classes. The Report class consolidates findings from the UnifiedKnowledgeGraph into summaries and recommendations, providing stakeholders with actionable insights for decision-making. Its attributes include summary and recommendations, while its methods generateSummary and generateRecommendations provide detailed guidance on optimizing feature use and functionality. The Visualization class enables users to interact with the graph dynamically, leveraging its attributes nodes and edges and methods render and allowInteraction.

The relationships among these classes are integral to the system's operation. The LargeLanguageModelProcessor analyzes the TechnicalDocumentation and SoftwareComponent classes, sending extracted features to the PlatformAgnosticPlugin, which generates knowledge graphs. These graphs are consolidated into the UnifiedKnowledgeGraph by the GraphConsolidationModule, validated by the SandboxTestingEnvironment, and updated by the DynamicLearningModule. The GenerativeAIEngine visualizes the graph, while the UserInterfaceModule facilitates user interaction, creating a feedback loop that ensures continuous refinement.

FIG. 4 exemplifies the invention's ability to integrate these components into a cohesive and adaptable system. By detailing the attributes and methods of each class and their interrelations, the diagram provides a clear and expansive understanding of how the invention achieves its goals of optimizing software development processes. The inclusion of iterative feedback loops, real-time updates, and dynamic user interaction highlights the system's scalability, modularity, and responsiveness to complex challenges, underscoring its transformative potential in the field of software engineering.

Pseudocode exemplars for implementing various aspects of this disclosure are set forth below with explanations for reference.

### // Initialization of Core Components

initialize LLMProcessor
initialize PlatformAgnosticPlugin
initialize GraphConsolidationModule
initialize GenAIEngine
initialize UserInterfaceModule
initialize DynamicLearningModule
initialize SandboxTestingEnvironment

### // Step 1: Extract Technical Features

function analyzeTechnicalDocumentation(softwareComponents):
   for component in softwareComponents:
      features=LLMProcessor.extractFeatures(component.documentation)
   prioritizeFeatures(features)
   generateKnowledgeGraph(component, features)

### // Step 2: Generate Knowledge Graphs

function generateKnowledgeGraph(component, features):
   graph=PlatformAgnosticPlugin.createGraph( )
   for feature in features:
      graph.addNode(feature, metadata=extractMetadata(feature))
      component.graph=graph

### // Step 3: Merge Knowledge Graphs

function mergeKnowledgeGraphs(components):
   unifiedGraph=GraphConsolidationModule.createUnifiedGraph( )
   for component in components:
      for node in component.graph.nodes:
      if not unifiedGraph.contains(node):
         unifiedGraph.addNode(node)
      else:
         unifiedGraph.mergeNode(node)
   resolveConflicts(unifiedGraph)
   return unifiedGraph

### // Step 4: Resolve Conflicts

function resolveConflicts(graph):
   for conflict in graph.detectConflicts( ):
      resolution=applyConflictResolutionProtocol(conflict)
      graph.updateNode(resolution)

### // Step 5: Visualize Unified Knowledge Graph

function visualizeUnifiedGraph(graph):
   visualization=GenAIEngine.generateVisualization(graph)
   return visualization

### // Step 6: Enable User Interaction

function enableUserInteraction(visualization):
   UserInterfaceModule.display(visualization)
      UserInterfaceModule.enableNodeModification(visualization, callback=updateUnifiedGraph)

### // Step 7: Update Unified Knowledge Graph

function updateUnifiedGraph(modifiedNode):
   DynamicLearningModule.updateNode(modifiedNode)
   DynamicLearningModule.versionControl( )

### // Step 8: Validate Features in Sandbox

function validateFeaturesInSandbox(graph):
   scenarios=SandboxTestingEnvironment.createScenarios(graph)
   for scenario in scenarios:
      results=SandboxTestingEnvironment.simulate(scenario)
      refineFeatures(results)

### // Step 9: Generate Reports

function generateFeatureReport(graph):
   report=GenAIEngine.generateReport(graph)
   return report

The pseudocode begins by initializing the core components of the system, including the LLM processor, platform-agnostic plugin, graph consolidation module, generative AI engine, user interface module, dynamic learning module, and sandbox testing environment. These components form the backbone of the system and are responsible for executing the various stages of the invention.

The first major function, ‘analyzeTechnicalDocumentation’, processes the documentation for each software component using the LLM processor. This function extracts technical features such as input/output specifications and prioritizes them based on criteria like frequency of use and complexity. The extracted features are then passed to ‘generateKnowledgeGraph’, which uses the platform-agnostic plugin to create a graph representing the features and their metadata.

The ‘mergeKnowledgeGraphs’ function consolidates the individual knowledge graphs into a unified graph. The graph consolidation module evaluates nodes from all graphs, adding unique nodes and merging identical nodes. It ensures no duplicates are present and preserves relationships between nodes. Conflicts in technical features are resolved using ‘resolveConflicts’, which applies a predefined protocol to update or modify conflicting nodes while maintaining consistency.

The unified graph is visualized using the ‘visualizeUnifiedGraph’ function. This function leverages the generative AI engine to create an interactive representation of the graph. The visualization is displayed to users through the ‘enableUserInteraction’ function, which uses the user interface module to allow modifications to nodes. Any changes made by users are automatically updated in the unified graph through the ‘updateUnifiedGraph’ function, which also manages version control using the dynamic learning module.

Validation of technical features is performed in the ‘validateFeaturesInSandbox’ function. The sandbox testing environment generates scenarios and simulates the integration and performance of features under different conditions. The results are used to refine the features for improved alignment with project requirements.

Finally, the ‘generateFeatureReport’ function produces a detailed report summarizing the technical features, their usage, and recommendations for reuse or enhancements. This report is generated by the generative AI engine and serves as a valuable resource for decision-making and future development efforts.

The pseudocode provides a high-level yet comprehensive view of the implementation, ensuring that each aspect of the invention is represented and integrated seamlessly.

A skilled artisan, upon reviewing the disclosure, will appreciate that there are numerous alternatives, modifications, combinations, and customizations that can be made to the systems and methods described herein.

The systems and methods described herein allow for a wide range of alternatives, modifications, combinations, and customizations that remain within the spirit and scope of the disclosure. These variations enable the invention to be tailored to specific use cases, technological environments, and organizational requirements while maintaining the core functionalities and objectives.

One alternative involves adapting the large language model (LLM) processor to handle non-traditional forms of technical documentation, such as visual diagrams, legacy codebases, or even audio explanations. This would allow the system to expand its applicability to domains where textual documentation is unavailable or insufficient. The LLM could be further customized to integrate with domain-specific ontologies, enhancing its ability to extract relevant features for niche applications like finance or aerospace.

A modification could involve the use of decentralized or distributed graph storage mechanisms, such as those based on Holochain, to ensure scalability and fault tolerance in environments with high data volumes. By decentralizing the knowledge graph infrastructure, the system could enable parallel processing and improved access control for large, multi-tenant organizations with sensitive data.

The platform-agnostic plugin could be extended to support emerging programming paradigms or technologies, such as quantum computing, low-code platforms, or blockchain-based smart contracts. This would allow the system to remain relevant as new technologies emerge, ensuring compatibility with cutting-edge software development practices.

Another customization could involve enhancing the conflict-resolution protocol employed by the graph consolidation module. For instance, the system could incorporate machine learning models trained to predict optimal resolutions for conflicting nodes based on historical data. This would allow for a more intelligent and context-aware merging process that adapts to the organization's unique development practices.

The generative artificial intelligence (GenAI) engine could be augmented to include advanced data visualization techniques, such as augmented reality (AR) or virtual reality (VR) representations of the knowledge graph. This would enable users to explore complex relationships in an immersive environment, which could be particularly valuable for large-scale systems with intricate dependencies.

The user interface module could be customized to include additional features such as collaborative editing tools, personalized views based on user roles, or integration with agile project management platforms. These enhancements would improve the system's usability and adoption across diverse teams and organizational workflows.

The dynamic learning module could be modified to integrate predictive analytics, enabling it to forecast trends in software feature usage or identify potential bottlenecks in development pipelines. This predictive capability would help organizations proactively address issues and optimize their resource allocation.

In terms of validation, the sandbox testing environment could be extended to include real-world data simulations or integration with continuous integration/continuous deployment (CI/CD) pipelines. This would enable the system to provide more accurate and actionable insights during the testing phase, ensuring that features meet production-quality standards before deployment.

Combinations of the described features could include integrating the system with existing enterprise software solutions, such as customer relationship management (CRM) systems, enterprise resource planning (ERP) platforms, or application performance monitoring (APM) tools. This would allow the system to become part of a broader ecosystem, leveraging existing data and workflows to enhance its functionality.

Customizations might involve tailoring the prioritization algorithm used by the LLM processor to reflect an organization's unique priorities or strategic goals. For example, a company focused on security might prioritize features related to encryption and data protection, while a startup might emphasize rapid prototyping and user interface innovations.

Additionally, the invention could be extended to support federated learning, allowing multiple organizations to collaborate on feature extraction and knowledge graph creation without sharing raw data. This approach would be particularly beneficial in industries with strict privacy regulations, enabling cross-organizational collaboration while maintaining data security.

Another modification could involve enabling real-time collaboration among multiple users within the visualization environment. This would allow teams to work together on graph exploration, feature evaluation, and decision-making, fostering a more collaborative and efficient development process.

The invention could also be adapted to support dynamic feature versioning, where nodes in the knowledge graph can branch into multiple versions based on different use cases or requirements. This would provide developers with greater flexibility in tailoring features to specific contexts while maintaining a record of their evolution.

Overall, the systems and methods described are highly modular and adaptable, allowing for a wide range of alternatives, modifications, combinations, and customizations. These variations ensure that the invention can be effectively applied across diverse domains, technologies, and organizational needs, while staying true to its core principles of efficiency, scalability, and innovation.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for optimizing software development processes, the method comprising:
providing, by a large language model (LLM) processor, an analysis of technical documentation associated with one or more software components, the analysis including extracting technical features, input specifications, and output specifications of each software component;
generating, by a platform-agnostic plugin, a knowledge graph for each of the one or more software components, wherein each knowledge graph comprises nodes representing the extracted technical features of the respective software component and edges representing dependencies between the nodes of the respective software component;
merging, by a graph consolidation module, the knowledge graphs into a unified knowledge graph, wherein merging includes filtering duplicate nodes across the knowledge graphs and identifying unique nodes using a map traversal algorithm;
combining, by the graph consolidation module, identical nodes within the unified knowledge graph that have minor variations, wherein combining incorporates enhancements to the technical features and preserves input and output edge relationships of the identical nodes;
feeding, by a generative artificial intelligence (GenAI) engine, the unified knowledge graph to generate a visual representation of the technical features represented in the unified knowledge graph, wherein the visual representation includes interactive elements configured to explore relationships and dependencies among the nodes of the unified knowledge graph;
enabling, by a user interface module, visualization and exploration of the technical features and their interconnections as represented in the visual representation, wherein the visualization facilitates evaluation and reuse of the technical features in additional software components;
updating, by a dynamic learning module, the unified knowledge graph upon modifications to the one or more software components, wherein the updating includes creating version-controlled revisions of the unified knowledge graph, the revisions being maintained with cryptographic hashes to ensure data integrity;
integrating, by the platform-agnostic plugin, additional software components developed in diverse technologies, wherein the integration includes extracting technical features of the additional software components and incorporating the extracted technical features into the unified knowledge graph; and
validating, by a sandbox testing environment, the suitability of the technical features represented in the visual representation for specific projects prior to implementation, wherein validating includes performing iterative refinements to optimize performance and alignment of the technical features with project requirements.

2. The method of claim 1, further comprising prioritizing, by the large language model processor, the extracted technical features based on predefined criteria, wherein the criteria include frequency of use, complexity, and relevance to current software development projects.

3. The method of claim 2, wherein the knowledge graphs generated by the platform-agnostic plugin include metadata for each node, the metadata comprising historical usage data, dependencies, and associated risks.

4. The method of claim 3, wherein merging the knowledge graphs into the unified knowledge graph further includes tagging, by the graph consolidation module, each node in the unified knowledge graph with a unique identifier, the unique identifier linking the node to its source software component.

5. The method of claim 4, further comprising detecting, by the graph consolidation module, conflicts among technical features during the merging process and resolving the conflicts based on a predefined conflict-resolution protocol.

6. The method of claim 5, wherein feeding the unified knowledge graph to the generative artificial intelligence engine includes generating multiple versions of the visual representation, each version tailored to a specific audience, including developers, project managers, and non-technical stakeholders.

7. The method of claim 6, wherein enabling visualization and exploration of the technical features further comprises allowing, by the user interface module, modifications to the nodes in the visual representation, the modifications being automatically reflected in the unified knowledge graph.

8. The method of claim 7, further comprising generating, by the generative artificial intelligence engine, a report summarizing the technical features represented in the unified knowledge graph, wherein the report includes recommendations for reuse, enhancements, or elimination of redundant features.

9. The method of claim 8, wherein updating the unified knowledge graph further includes monitoring, by the dynamic learning module, changes in the source software components in real-time, the monitoring triggering automated updates to the unified knowledge graph upon detecting changes.

10. The method of claim 9, wherein validating the technical features in the sandbox testing environment further includes simulating, by the sandbox testing environment, integration scenarios for the technical features to assess compatibility and performance in multi-component systems.

11. A method for optimizing software development processes, the method comprising:
analyzing, by a large language model (LLM) processor, technical documentation associated with one or more software components, wherein the analysis includes extracting technical features, input specifications, and output specifications of each software component;
prioritizing, by the LLM processor, the extracted technical features based on predefined criteria, wherein the criteria include frequency of use, complexity, and relevance to current software development projects;
generating, by a platform-agnostic plugin, a knowledge graph for each of the one or more software components, wherein each knowledge graph comprises nodes representing the extracted technical features of the respective software component and edges representing dependencies between the nodes of the respective software component, the nodes being annotated with metadata comprising historical usage data, dependencies, and associated risks;
merging, by a graph consolidation module, the knowledge graphs into a unified knowledge graph, wherein merging includes filtering duplicate nodes across the knowledge graphs, identifying unique nodes using a map traversal algorithm, and tagging each node with a unique identifier linking the node to its source software component;
resolving, by the graph consolidation module, conflicts among technical features during the merging process based on a predefined conflict-resolution protocol, the conflicts being detected through an evaluation of overlapping functionality or contradictory dependencies;
combining, by the graph consolidation module, identical nodes within the unified knowledge graph that have minor variations, wherein combining incorporates enhancements to the technical features and preserves input and output edge relationships of the identical nodes;
feeding, by a generative artificial intelligence (GenAI) engine, the unified knowledge graph to generate a visual representation of the technical features represented in the unified knowledge graph, wherein the visual representation includes interactive elements configured to explore relationships and dependencies among the nodes of the unified knowledge graph;
generating, by the GenAI engine, multiple versions of the visual representation tailored to specific audiences, including developers, project managers, and non-technical stakeholders, the versions differing in granularity and terminology appropriate to the intended audience;
enabling, by a user interface module, visualization and exploration of the technical features and their interconnections as represented in the visual representation, wherein the visualization facilitates evaluation and reuse of the technical features in additional software components, the user interface module further allowing modifications to the nodes in the visual representation, the modifications being automatically reflected in the unified knowledge graph;
generating, by the GenAI engine, a report summarizing the technical features represented in the unified knowledge graph, the report including recommendations for reuse, enhancements, or elimination of redundant features;
updating, by a dynamic learning module, the unified knowledge graph upon modifications to the one or more software components, wherein updating includes monitoring changes in the source software components in real-time, the monitoring triggering automated updates to the unified knowledge graph, and creating version-controlled revisions of the unified knowledge graph, the revisions being maintained with cryptographic hashes to ensure data integrity;
integrating, by the platform-agnostic plugin, additional software components developed in diverse technologies, wherein integrating includes extracting technical features of the additional software components and incorporating the extracted technical features into the unified knowledge graph; and
validating, by a sandbox testing environment, the suitability of the technical features represented in the visual representation for specific projects prior to implementation, wherein validating includes simulating integration scenarios for the technical features to assess compatibility and performance in multi-component systems, and performing iterative refinements to optimize performance and alignment of the technical features with project requirements.

12. A system for optimizing software development processes, the system comprising:
a large language model (LLM) processor configured to analyze technical documentation associated with one or more software components, wherein the analysis includes extracting technical features, input specifications, and output specifications of each software component, and further configured to prioritize the extracted technical features based on predefined criteria, including frequency of use, complexity, and relevance to current software development projects;
a platform-agnostic plugin configured to generate a knowledge graph for each of the one or more software components, wherein each knowledge graph comprises nodes representing the extracted technical features of the respective software component and edges representing dependencies between the nodes of the respective software component, the nodes being annotated with metadata comprising historical usage data, dependencies, and associated risks;
a graph consolidation module configured to merge the knowledge graphs into a unified knowledge graph, wherein the merging includes filtering duplicate nodes across the knowledge graphs, identifying unique nodes using a map traversal algorithm, and tagging each node with a unique identifier linking the node to its source software component;
the graph consolidation module further configured to resolve conflicts among technical features during the merging process based on a predefined conflict-resolution protocol, the conflicts being detected through an evaluation of overlapping functionality or contradictory dependencies, and to combine identical nodes within the unified knowledge graph that have minor variations, wherein combining incorporates enhancements to the technical features and preserves input and output edge relationships of the identical nodes;
a generative artificial intelligence (GenAI) engine configured to receive the unified knowledge graph and generate a visual representation of the technical features represented in the unified knowledge graph, wherein the visual representation includes interactive elements configured to explore relationships and dependencies among the nodes of the unified knowledge graph, and further configured to generate multiple versions of the visual representation tailored to specific audiences, including developers, project managers, and non-technical stakeholders;
a user interface module configured to enable visualization and exploration of the technical features and their interconnections as represented in the visual representation, wherein the visualization facilitates evaluation and reuse of the technical features in additional software components, the user interface module further allowing modifications to the nodes in the visual representation, the modifications being automatically reflected in the unified knowledge graph;
the GenAI engine further configured to generate a report summarizing the technical features represented in the unified knowledge graph, the report including recommendations for reuse, enhancements, or elimination of redundant features;
a dynamic learning module configured to update the unified knowledge graph upon modifications to the one or more software components, wherein the updating includes monitoring changes in the source software components in real-time, the monitoring triggering automated updates to the unified knowledge graph, and creating version-controlled revisions of the unified knowledge graph, the revisions being maintained with cryptographic hashes to ensure data integrity;
the platform-agnostic plugin further configured to integrate additional software components developed in diverse technologies, wherein integrating includes extracting technical features of the additional software components and incorporating the extracted technical features into the unified knowledge graph; and
a sandbox testing environment configured to validate the suitability of the technical features represented in the visual representation for specific projects prior to implementation, wherein validating includes simulating integration scenarios for the technical features to assess compatibility and performance in multi-component systems, and performing iterative refinements to optimize performance and alignment of the technical features with project requirements.

13. The system of claim 12, wherein the large language model processor is further configured to classify the extracted technical features into predefined categories based on their functionality, including but not limited to data security, user interface design, and system integration.

14. The system of claim 13, wherein the platform-agnostic plugin is further configured to annotate each node in the knowledge graph with contextual information, the contextual information including the source software component's development environment, associated technologies, and implementation constraints.

15. The system of claim 14, wherein the graph consolidation module is further configured to detect inconsistencies among the dependencies of nodes during the merging process and to resolve the inconsistencies by modifying edge relationships while preserving the logical integrity of the unified knowledge graph.

16. The system of claim 15, wherein the generative artificial intelligence engine is further configured to provide predictive insights into the potential usage of the technical features based on historical usage data and patterns identified within the unified knowledge graph.

17. The system of claim 16, wherein the user interface module is further configured to enable users to filter and search for technical features in the visual representation based on predefined criteria, including technical functionality, dependencies, and metadata attributes.

18. The system of claim 17, wherein the dynamic learning module is further configured to compare real-time updates to the unified knowledge graph with historical versions, the comparison identifying potential conflicts or redundancies introduced by the updates and suggesting resolutions.

19. The system of claim 18, wherein the platform-agnostic plugin is further configured to generate compatibility reports for additional software components integrated into the unified knowledge graph, the reports including recommendations for adjustments required to ensure seamless integration.

20. The system of claim 19, wherein the sandbox testing environment is further configured to perform stress testing of the technical features represented in the visual representation, wherein the stress testing evaluates the features under simulated high-load and edge-case conditions to ensure robustness and scalability.
